(19) United States
(12) Patent Application Publication
(10) Pub. No.: US 2023/0129107 A1
(43) Pub. Date: Apr. 27, 2023

(54) METHOD AND APPARATUS TO AGGREGATE OBJECTS TO BE STORED IN A MEMORY TO OPTIMIZE THE MEMORY BANDWIDTH

(71) Applicant: Intel Corporation, Santa Clara, CA (US)

(72) Inventors: Iliya BOKHMAN, Be'er Sheva (IL); Elazar COHEN, Haifa (IL)

(21) Appl. No.: 18/086,030

(22) Filed: Dec. 21, 2022

(51) Int. Cl. G06F 12/0891; G06F 12/0804

(52) U.S. Cl. CPC G06F 12/0891; G06F 12/0804

(57) ABSTRACT

A network device performs packet processing operations on packets received from a network and includes a write back cache to store data (for example, counters) used to perform the packet processing operations. The data stored in the write cache in the network device are evicted from the write back cache to an external memory from time to time using a write-back operation that includes a read-modify-write of a line in the external memory. Instead of performing a separate read-modify-write for each data stored in the cache line, a single read-modify-write operation is performed for all data stored in the cache line in the write back cache. The aggregation of relatively close data for the single read-modify-write operation reduces the number of memory accesses to the external memory and improves the bandwidth to the external memory.

### BACKGROUND

Cloud computing provides access to servers, storage, databases, and a broad set of application services over the Internet. A cloud service provider offers cloud services such as network services and business applications that are hosted in servers in one or more data centers that can be accessed by companies or individuals over the Internet. Hyperscale cloud-service providers typically have hundreds of thousands of servers. Each server in a hyperscale cloud includes storage devices to store user data, for example, user data for business intelligence, data mining, analytics, social media and microservices. The cloud service provider generates revenue from companies and individuals (also referred to as tenants) that use the cloud services.

Disaggregated computing or Composable Disaggregated Infrastructure (CDI) is an emerging technology that makes use of high bandwidth, low-latency interconnects to aggregate compute, storage, memory, and networking fabric resources into shared resource pools that can be provisioned on demand.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system for executing one or more workloads;

FIG. 2 is a simplified block diagram of at least one embodiment of a compute node in the system shown in FIG. 1;

FIG. 3 illustrates a compute node that includes an Infrastructure Processing Unit (IPU) and an xPU;

FIG. 4 is a block diagram of an embodiment of the network processor shown in FIG. 3;

FIG. 5 is an example of a pending linked list to store objects evicted from the write back cache to be written to external memory; and

FIG. 6 is a flowgraph of a method performed by the write-back engine to update an evicted object in the memory line in the external memory.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

High speed networks are essential for supporting business, providing communication, and delivering entertainment. To increase network speed, Cloud service providers (CSPs) are evolving their hardware platforms by offering central processing units (CPUs), general purpose graphics processing units (GPGPUs), custom XPUs, and pooled storage and memory (for example, DDR, persistent memory, 3D XPoint, Optane, or memory devices that use chalcogenide glass). CSPs are vertically integrating these with custom orchestration control planes to expose these as services to users.

Growth in cloud native, scale out in applications, emergence of Compute Express Link (CXL) based protocols to stitch together systems and resources across multiple platforms, and increased and enhanced usages and capabilities offered by XPUs (for example, GPUs and Infrastructure Processing Units (IPUs)) have led a shift from core and CPU focused computing, to computing that spans multiple platforms and even multiple datacenters at times.

A network device, for example, an Infrastructure Processing Unit (IPU), data processing unit (DPU) or Smart Network Interface Controller (NIC) performs packet processing operations on packets received from a network and includes a write back cache to store objects (for example, counters) used to perform the packet processing operations. The data bus width (line) of the external memory can be greater than the number of data bits in an object. The objects stored in the write back cache in the network device are evicted from the write back cache to the external memory from time to time using a write-back operation that includes a read-modify-write of a line in the external memory.

For relatively small objects (for example, 16 Bytes (16B), the write-back operation to external memory required per object involves a read-modify-write of the full memory line (for example, 64B, 128B, 256B or greater than 25B). For example, a line width in the external memory can be N where N is an integer multiple of 4 (for example, 64B) and an object width can be N/4 (for example, 16B). A 16B counter stored in cache is evicted by reading the 64B line from the external memory, modifying the 16B count stored in the 64B line to add the count stored in the 16B counter in cache to the 64B line read from the external memory and writing the modified 64B line to external memory.

During a burst of evictions, for example to evict all objects stored in the cache (referred to as a clean-up flow), a cache line in the cache can be accessed multiple times to perform a read-modify-write for each object stored in the cache line. For example, if a 64B cache line stores four 16B objects, the cache line is accessed four times to perform a read-modify-write for each object stored in the cache line.

Instead of performing a separate read-modify-write for each object stored in the cache line, a single read-modify-write operation is performed in external memory for all objects stored in the cache line. The aggregation of relatively close objects for the single read-modify-write operation reduces the number of memory accesses to external memory and improves the bandwidth to external memory.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

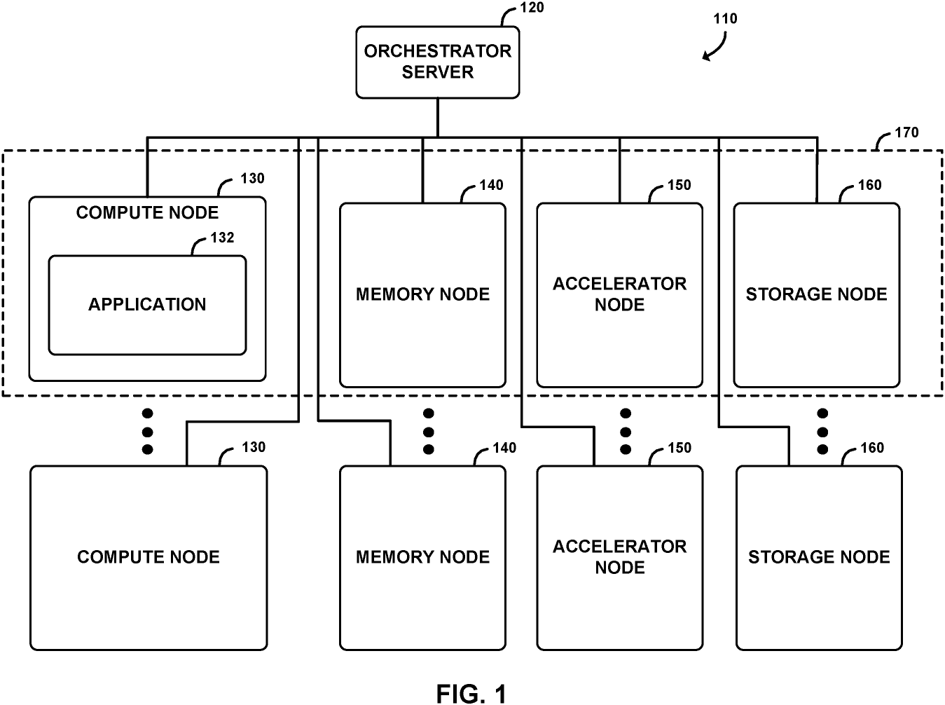

FIG. 1 is a block diagram of a system 110 for executing one or more workloads. Examples of workloads include applications and microservices. A data center can be embodied as a single system 110 or can include multiple systems. The system 110 includes multiple nodes, some of which may be equipped with one or more types of resources (e.g., memory devices, data storage devices, accelerator devices, general purpose processors, Graphics Processing Units (GPUs), x Processing Units (xPUs), Central Processing Units (CPUs), field programmable gate arrays (FPGAs), or application-specific integrated circuits (ASICs)).

In the illustrative embodiment, the system 110 includes an orchestrator server 120, which may be embodied as a managed node comprising a compute device (for example, a processor on a compute node) executing management software (for example, a cloud operating environment, such as OpenStack) that is communicatively coupled to multiple nodes including a large number of compute nodes 130, memory nodes 140, accelerator nodes 150, and storage nodes 160. A memory node is configured to provide other nodes with access to a pool of memory. One or more of the nodes 130, 140, 150, 160 may be grouped into a managed node 170, such as by the orchestrator server 120, to collectively perform a workload (for example, an application 132 executed in a virtual machine or in a container). While orchestrator server 120 is shown as a single entity, alternatively or additionally, its functionality can be distributed across multiple instances and physical locations.

The managed node 170 may be embodied as an assembly of physical resources, such as processors, memory resources, accelerator circuits, or data storage, from the same or different nodes. Further, the managed node 170 may be established, defined, or “spun up” by the orchestrator server 120 at the time a workload is to be assigned to the managed node 170, and may exist regardless of whether a workload is presently assigned to the managed node 170. In the illustrative embodiment, the orchestrator server 120 may selectively allocate and/or deallocate physical resources from the nodes and/or add or remove one or more nodes from the managed node 170 as a function of quality of service (QoS) targets (for example, a target throughput, a target latency, a target number of instructions per second, etc.) associated with a service level agreement or class of service (COS or CLOS) for the workload (for example, the application 132). In doing so, the orchestrator server 120 may receive telemetry data indicative of performance conditions (for example, throughput, latency, instructions per second, etc.) in each node of the managed node 170 and compare the telemetry data to the quality-of-service targets to determine whether the quality of service targets are being satisfied. The orchestrator server 120 may additionally determine whether one or more physical resources may be deallocated from the managed node 170 while still satisfying the QoS targets, thereby freeing up those physical resources for use in another managed node (for example, to execute a different workload). Alternatively, if the QoS targets are not presently satisfied, the orchestrator server 120 may determine to dynamically allocate additional physical resources to assist in the execution of the workload (for example, the application 132) while the workload is executing. Similarly, the orchestrator server 120 may determine to dynamically deallocate physical resources from a managed node 170 if the orchestrator server 120 determines that deallocating the physical resource would result in QoS targets still being met.

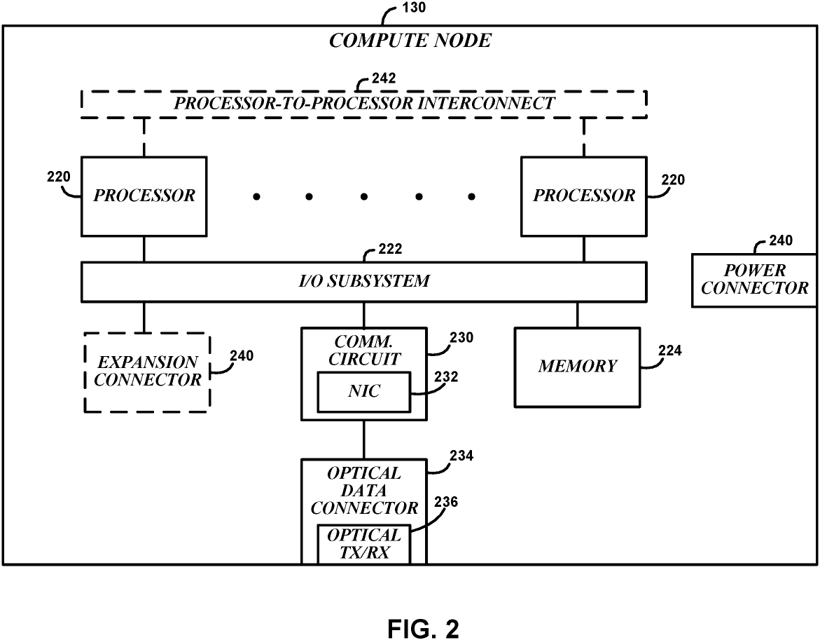

FIG. 2 is a simplified block diagram of at least one embodiment of a compute node 130 in the system shown in FIG. 1. The compute node 130 can be configured to perform compute tasks. As discussed above, the compute node 130 may rely on other nodes, such as acceleration nodes 150 and/or storage nodes 160, to perform compute tasks. In the illustrative compute node 130, physical resources are embodied as processors 220. Although only two processors 220 are shown in FIG. 2, it should be appreciated that the compute node 130 may include additional processors 220 in other embodiments. Illustratively, the processors 220 are embodied as high-performance processors 220 and may be configured to operate at a relatively high power rating.

In some embodiments, the compute node 130 may also include a processor-to-processor interconnect 242. Processor-to-processor interconnect 242 may be embodied as any type of communication interconnect capable of facilitating processor-to-processor interconnect 242 communications. In the illustrative embodiment, the processor-to-processor interconnect 242 is embodied as a high-speed point-to-point interconnect. For example, the processor-to-processor interconnect 242 may be embodied as a QuickPath Interconnect (QPI), an UltraPath Interconnect (UPI), or other high-speed point-to-point interconnect utilized for processor-to-processor communications (for example, Peripheral Component Interconnect express(PCIe) or Compute Express Link™ (CXL™)).

The compute node 130 also includes a communication circuit 230. The illustrative communication circuit 230 includes a network interface controller (NIC) 232, which may also be referred to as a host fabric interface (HFI). The NIC 232 may be embodied as, or otherwise include, any type of integrated circuit, discrete circuits, controller chips, chipsets, add-in-boards, daughtercards, network interface cards, or other devices that may be used by the compute node 130 to connect with another compute device (for example, with other nodes). In some embodiments, the NIC 232 may be embodied as part of a system-on-a-chip (SoC) that includes one or more processors, or included on a multichip package that also contains one or more processors. In some embodiments, the NIC 232 may include a local processor (not shown) and/or a local memory (not shown) that are both local to the NIC 232. In such embodiments, the local processor of the NIC 232 may be capable of performing one or more of the functions of the processors 220. Additionally, or alternatively, in such embodiments, the local memory of the NIC 232 may be integrated into one or more components of the compute node 130 at the board level, socket level, chip level, and/or other levels. In some examples, a network interface includes a network interface controller or a network interface card. In some examples, a network interface can include one or more of a network interface controller (NIC) 232, a host fabric interface (HFI), a host bus adapter (HBA), network interface connected to a bus or connection (for example, PCIe or CXL). In some examples, a network interface can be part of a switch or a system-on-chip (SoC).

Some examples of a NIC 232 are part of an Infrastructure Processing Unit (IPU) or Data Processing Unit (DPU) or utilized by an IPU or DPU. An IPU or DPU can include a network interface, memory devices, and one or more programmable or fixed function processors (for example, CPU or XPU) to perform offload of operations that could have been performed by a host CPU or XPU or remote CPU or XPU. In some examples, the IPU or DPU can perform virtual switch operations, manage storage transactions (for example, compression, cryptography, virtualization), and manage operations performed on other IPUs, DPUs, servers, or devices.

The communication circuit 230 is communicatively coupled to an optical data connector 234. The optical data connector 234 is configured to mate with a corresponding optical data connector of a rack when the compute node 130 is mounted in the rack. Illustratively, the optical data connector 234 includes a plurality of optical fibers which lead from a mating surface of the optical data connector 234 to an optical transceiver 236. The optical transceiver 236 is configured to convert incoming optical signals from the rack-side optical data connector to electrical signals and to convert electrical signals to outgoing optical signals to the rack-side optical data connector. Although shown as forming part of the optical data connector 234 in the illustrative embodiment, the optical transceiver 236 may form a portion of the communication circuit 230 in other embodiments.

The I/O subsystem 222 may be embodied as circuitry and/or components to facilitate Input/Output operations with memory 224 and communications circuit 230. In some embodiments, the compute node 130 may also include an expansion connector 240. In such embodiments, the expansion connector 240 is configured to mate with a corresponding connector of an expansion circuit board substrate to provide additional physical resources to the compute node 130. The additional physical resources may be used, for example, by the processors 220 during operation of the compute node 130. The expansion circuit board substrate may include various electrical components mounted thereto. The particular electrical components mounted to the expansion circuit board substrate may depend on the intended functionality of the expansion circuit board substrate. For example, the expansion circuit board substrate may provide additional compute resources, memory resources, and/or storage resources. As such, the additional physical resources of the expansion circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits. Note that reference to GPU or CPU herein can in addition or alternatively refer to an XPU or xPU. An xPU can include one or more of: a GPU, ASIC, FPGA, or accelerator device.

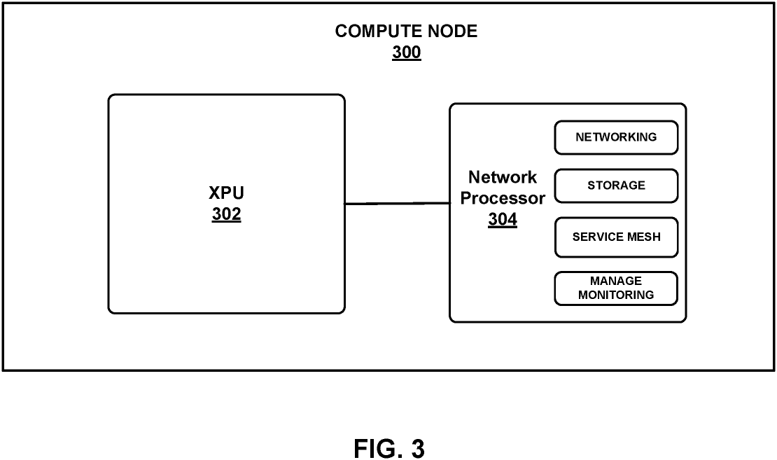

FIG. 3 illustrates a compute node 300 that includes a network processor 304 and an xPU 302. An XPU or xPU can refer to a Central processing unit (CPU), graphics processing unit (GPU), general purpose GPU (GPGPU), field programmable gate array (FPGA), Accelerated Processing Unit (APU), Artificial Intelligence processing Unit (AIPU), an Image / Video Processing Unit (VPU), accelerator or another processor. These can also include functions such as quality of service enforcement, tracing, performance and error monitoring, logging, authentication, service mesh, data transformation, etc.

The network processor 304 can be an Infrastructure Processing Unit (IPU) also referred to as a Data Processing Unit (DPUs) that can be used by CSPs for performance, management, security and coordination functions in addition to infrastructure offload and communications. For example, IPUs can be integrated with smart NICs and storage or memory (for example, on a same die, system on chip (SoC), or connected dies) that are located at on-premises systems, base stations, gateways, neighborhood central offices, and so forth.

The network processor 304 can perform an application composed of microservices. Microservices can include a decomposition of a monolithic application into small manageable defined services. Each microservice runs in its own process and communicates using protocols (for example, a Hypertext Transfer Protocol (HTTP) resource application programming interfaces (API), message service or Google remote procedure call (gRPC) calls/messages). Microservices can be independently deployed using centralized management of these services.

The network processor 304 can execute platform management, networking stack processing operations, security (crypto) operations, storage software, identity and key management, telemetry, logging, monitoring and service mesh (e.g., control how different microservices communicate with one another). The network processor 304 can access the xPU 302 to offload performance of various tasks.

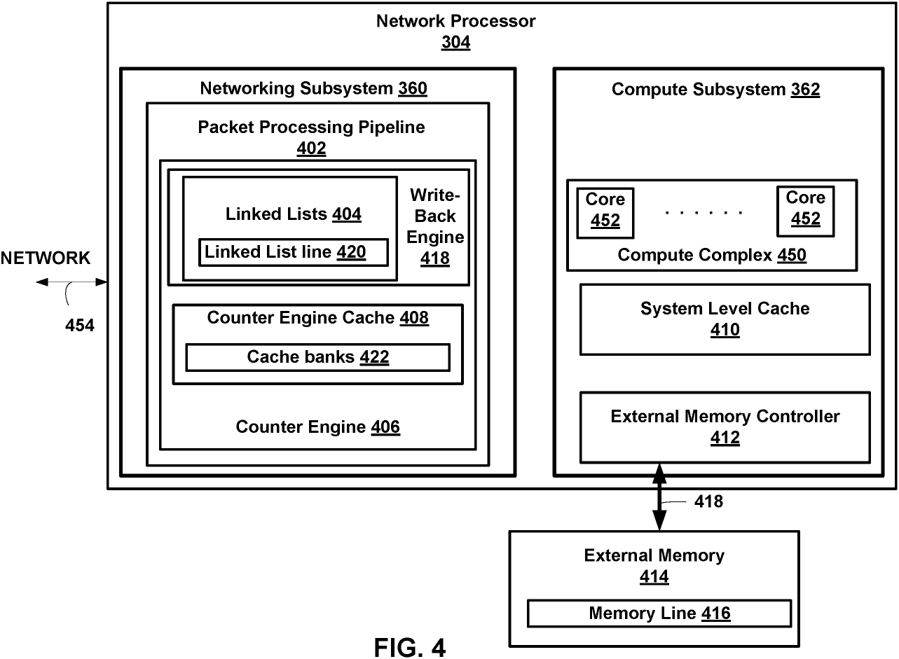

FIG. 4 is a block diagram of an embodiment of the network processor 304 shown in FIG. 3. As discussed in conjunction with FIG. 3, the network processor 304 can be an Infrastructure Processing Unit (IPU) also referred to as a Data Processing Unit (DPU).

The network processor 304 includes a networking subsystem 360 and a compute subsystem 362. The compute subsystem 362 includes a compute complex 450, a system level cache 410 and an external memory controller 412. The compute complex 450 includes a plurality of cores 452. The external memory controller 412 manages access to an external memory 414.

The external memory 414 can be a volatile memory and the external memory controller 412 can be a volatile memory controller. Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, originally published in September 2012 by JEDEC), DDR5 (DDR version 5, originally published in July 2020), LPDDR3 (Low Power DDR version 3, JESD209-3B, originally published in August 2013 by JEDEC), LPDDR4 (LPDDR version 4, JESD209-4, originally published by JEDEC in August 2014), LPDDR5 (LPDDR version 5, JESD209-5A, originally published by JEDEC in January 2020), WIO2 (Wide Input/Output version 2, JESD229-2 originally published by JEDEC in August 2014), HBM (High Bandwidth Memory, JESD235, originally published by JEDEC in October 2013), HBM2 (HBM version 2, JESD235C, originally published by JEDEC in January 2020), or HBM3 (HBM version 3 currently in discussion by JEDEC), or others or combinations of memory technologies, and technologies based on derivatives or extensions of such specifications. The JEDEC standards are available at www.jedec.org.

The networking subsystem 360 includes a packet processing pipeline 402. The packet processing pipeline 402 (also referred to as packet processing circuitry) processes packets (also referred to as network packets) received over the network 454 and packets to be transmitted over the network 454. The packet processing pipeline 402 includes a counter engine 406 (also referred to as counter circuitry) that includes a write-back engine 418 (also referred to as memory access circuitry) and counter engine cache 408. The write-back engine 418 includes linked lists (LL) 404. The counter engine cache 408 is based on set associative cache and can include write-back cache and write-through-cache.

The counter engine 406 includes counters (also referred to as telemetry counters) used to collect telemetry data for the packet processing pipeline 402. Telemetry is a term for collecting information in the form of measurements or statistical data. The counter engine 406 increments statistic counters used to collect statistical data based on metadata or in response to an action. An action is a directive generated by the packet processing pipeline 402, based on classification, which is an explicit request for counting an event.

The packet processing pipeline 402 can generate metadata based on classification flows. The metadata can include Virtual Station Interface (VSI), or Switch identifier (ID), which are indications for the source of the packet in the network 454, or the destination of the packet in the network 454. Statistic counters can be applied for the metadata. For example, a statistic counter can be used to count all packets associated with a VSI.

The statistic counters (which can be referred to as telemetry counters) collect telemetry data of incoming packets and store them in cache banks 422 in the counter engine cache 408. Each bank in cache banks 422 stores the delta count for the statistic counters. The delta count is the difference between a first value stored in a statistic counter in the counter engine 406 and a second value stored in a memory line 416 in the external memory 414.

The counter engine cache 408 in the counter engine 406 in the packet processing pipeline 402 includes a plurality of linked lists 404 that are used to store objects (for example, counters) used by the packet processing pipeline 402 to perform packet processing operations. The number of bytes in each linked list line 420 in the linked lists 404 is the same as a number of bytes in the memory line 416 in the external memory 414 and is also the same as the number of bytes in the data bus of the external memory 414.

The counters are stored in cache banks 422 in the counter engine cache 408 in counter engine 406. Objects stored in linked lists 404 in the write-back engine 418 in the network processor 304 are written back to external memory 414 from time to time using a write-back operation that includes a read-modify-write of a memory line 416 in the external memory 414. The linked list line 420 can store more than one object (for example, counter values). For example, a linked list line 420 that is N Bytes can store four N/4 Bytes objects. In an embodiment, N is 64 Bytes and N/4 is 16 Bytes.

Objects evicted from the counter engine cache 408 are sent to the write-back engine 418 and stored in linked lists 404 in the write-back engine 418. When the count stored in a counter has reached the maximum value, all of the cache banks 422 are being used, or a notification event is triggered (for example, an external trigger is received), the counter is evicted to the write-back engine 418. Examples of an external trigger include expiration of a hardware watchdog timer or a software flush request. The evicted counters are organized in linked list lines 420 in the linked lists 404 for read-modify-write operations by the write-back engine 418 to external memory 414.

When a notification event is triggered, the counter engine 406 selects one or more of the statistic counters stored in the cache banks 422 to be evicted from the cache banks 422 in the counter engine cache 408. The evicted counter values are written to linked lists 404 in the write-back engine 418 prior to being written to a memory line 416 in the external memory 414. While the accumulated counter values are written by the write-back engine 418 to the memory line 416 in the external memory 414, a counter notification packet is generated to notify a host entity (for example, a software entity) that consumes and uses the statistical counters (for example, a subscriber for the statistical counters) that the counters have been updated in the external memory 414.

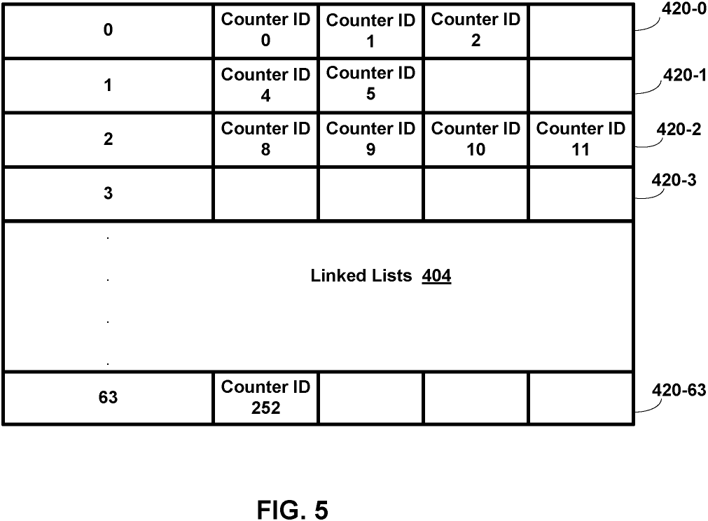

FIG. 5 is an example of the linked lists 404 shown in FIG. 4 to store objects evicted (evicted data) from the counter engine cache 408 to be written to external memory 414. In the example shown, the objects (evicted data) are counters. The linked lists 404 shown in FIG. 5 have 256 entries (also referred to as data fields) to store counters evicted from cache banks 422. The 256 entries are arranged in 64 link list lines 420 with four entries (data fields) per link list line 420. Each of the data fields in the line to store evicted data. Each link list line 420 in the linked lists 404 corresponds to a memory line 416 in the external memory 414. A link list line 420 in the linked lists 404 has the same number of bytes as the memory line 416 in the external memory 414.

The write-back engine 418 checks each received evicted object for a match based on its identifier in the linked lists 404. There are 2 types of matches, same identifier and close identifier. A close identifier is an identifier in the same link list line 420. For example, counter identifiers (counter ID 0, counter ID 1, counter ID 2) in a first link list line 420-0 are close identifiers. The write-back engine 418 performs a read-modify-write operation to update the evicted object in the memory line 416 in external memory 414. The write-back engine 418 sends a read request to read the memory line 416 in external memory 414 corresponding to the first link list line 420-0 in linked lists 404. The write-back engine 418 adds the counter values returned in response to the read request with the counter values for counter ID 0, counter ID 1 and counter ID 2 in the first link list line 420-0 and writes the result to the memory line 416 in external memory 414 corresponding to the first link list line 420-0 in linked lists 404.

Multiple accesses to the same entry (data field) in the linked list line 420 in the linked lists 404 and access to neighboring entries (data fields) in the same memory line 416 are stored in linked list lines 420 in linked lists 404 according to the memory line 416 in the external memory 414. The evicted data is written to multiple data fields in the linked list line 420 at different times.

A read-modify-write operation is performed to store the objects evicted from the counter engine cache 408 in the external memory 414. The objects evicted from the counter engine cache 408 are stored in the linked list lines 420-0,., 420-63 in the linked lists 404 in the write-back engine 418 in the same format as they are stored in a memory line 416 in the external memory 414.

A read request for the memory line 416 in external memory 414 is sent to the external memory 414 by the external memory controller 412. While the read request for the memory line 416 is processed by the external memory controller 412, other requests for the memory line 416 can be added to a link list line 420 in the link lists 404.

For example, linked list line 420-0 is created in linked lists 404 in response to a request to evict counter identifier (ID) 2, if linked list line 420-0 is not already in linked lists 404. A read request is sent to external memory 414 to read the memory line 416 that stores the counter value for counter ID 2 and also stores the counter values for counter ID 0, counter ID 1 and counter ID 3.

If requests to evict any of the other counters (counter ID 0, counter ID 1 and counter ID 3) in linked list line 420-0 are received prior to receiving the response for the read request for the memory line 416, the counter values for the other counters are written in the linked list line 420-0.

After the response to the read request for the memory line 416 is received, the received data read for counter IDs (0-3) from memory line 416 is summed with data stored in linked list line 420-0 in linked lists 404. Each entry in the memory line 416 is summed with the respective entry in the linked list line 420-0. If the linked list line 420-0 includes empty entries (with value 0), 0 is added to the respective entries in memory line 416. The result of the summation is written to the memory line 416 in external memory 414.

In the case in which an entry stores a counter value each access to the external memory 414 adds a value stored for the counter in an entry in the linked list line 420 to the counter value stored in a memory line 416 in the external memory 414 by performing a read- modify-write operation to the memory line 416 in the external memory 414. Multiple updates can be performed to the same counter in the linked list line 420 to add to the value stored in the counter in the linked list line 420, before the write back operation of the linked list line 420 to the memory line 416 in the external memory 414 is performed. For example, a first counter value for a counter can be evicted from the counter engine cache 408 when the counter value reaches the maximum threshold or when it is flushed. While the first counter value that is evicted when it reaches the maximum threshold is stored in a linked list line 420 in the linked lists 404, the write-back engine 418 can issue a read request from the external memory 414. If a second counter value for the counter is flushed before the first read request has been completed, the first counter value and the second counter value for the counter are summed in the linked list line 420 prior to writing the linked list line 420 in the memory line 416 in external memory 414.

While the read request for the memory line 416 is processed by the external memory controller 412, each new evicted counter is checked for an exact match or a close match in linked list lines 420-0,..420-63 in the linked lists 404. When the counter value reaches the maximum value (maximum threshold), the counter value is evicted and written back to the memory line 416 in the external memory 414. The counter (also referred to as a delta counter) starts the count value at zero and counts new packets as the packets arrive from network 454 after the counter value is evicted from counter engine cache 408.

If the counter identifier is in a linked list line 420 in the linked lists 404, the value stored in the evicted counter is added to the counter identifier in the linked list line 420 in linked lists 404. If a counter identifier for the memory line 416 is in an entry in the linked list lines 420-0,..420-63 in linked lists 404, the same counter identifier entry from the memory line 416 is added to the entry in the linked lists 404 and written back to the corresponding memory line 416 in the external memory 414. This allows the read-modify-write flow to be performed for all entries in a linked list line 420-0,..420-63 in linked lists 404 for the memory line 416 in a single read cycle from the external memory 414 and a single write cycle to the external memory 414. Thus, the number of read-modify-write accesses to the external memory 414 are reduced based on the ratio of 1:number of objects per linked list line 420 which improves the bandwidth to the external memory 414.

Aggregating same and close objects in the linked list lines 420-0,..420-63 in linked list 404 reduces the number of accesses to external memory 414 and decreases the latency of accesses to external memory 414. In an embodiment in which there are N objects per memory line 416 in external memory 414, the number of accesses to the external memory 414 to perform a read-modify-write operation is 2*N which uses the maximum bandwidth (bandwidth of the external memory) divided by N. The number of accesses to external memory 414 per linked list line 420 is reduced to 2, irrespective to how many objects are waiting for a read-modify-write operation to the same memory line 416 in external memory 414 and the bandwidth of the external memory 414 is Maximum Bandwidth (MaxBW).

Telemetry context cache requires periodic alignment of the on-die content with host software tables. This is performed using bulk eviction of cache content to external memory 414. Other examples of dynamic contexts are stateful packet processing hardware offloads, in which hardware stores a dynamic context of a flow and aligns with software from time to time.

Aggregating same and close objects in linked list lines 420-0,..420-63 in the linked lists 404 can be used for L1/L2 caches, snooping flows, write-through caches, internal memories, and/or Synchronous Dynamic Random Access Memory (SDRAM)/DRAM that requires periodic or random object alignment with memory and any read-modify-write flows to external memory 414.

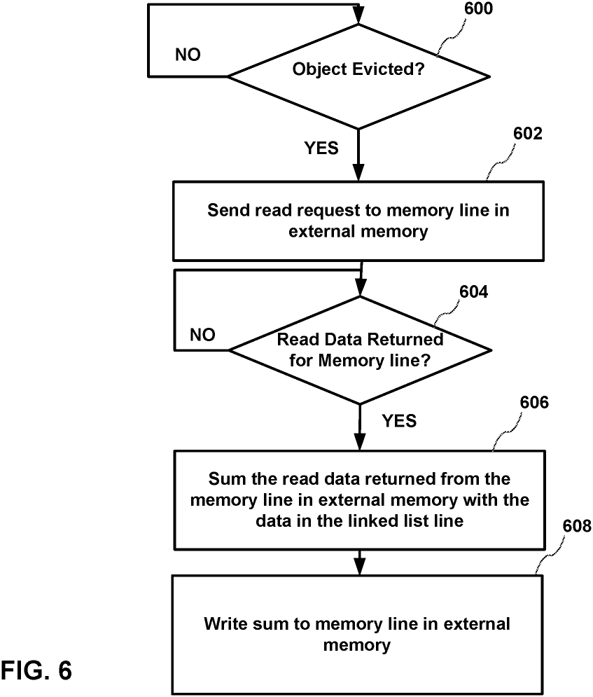

FIG. 6 is a flowgraph of a method performed by the write-back engine 418 to update an evicted object in the memory line 416 in the external memory 414.

At block 600, the write-back engine 418 monitors received evicted objects. The evicted objects are stored in linked list lines 420-0,..420-63 in the linked lists 404 in the write-back engine 418 in the same format as they are stored in a memory line 416 in the external memory 414. Upon receiving an evicted object, processing continues with block 602.

At block 602, the write-back engine 418 performs a read-modify-write operation to update the evicted object in the memory line 416 in external memory 414. The write-back engine 418 sends a read request to read the memory line 416 in external memory 414. A read request for the memory line 416 in external memory 414 is sent to the external memory 414 by the external memory controller 412. Processing continues with block 604.

At block 604, while the read request for the memory line 416 is processed by the external memory controller 412, other requests for the memory line 416 can be added to a link list line 420 in the link lists 404. Multiple accesses to the same entry in a linked list line 420 in the linked lists 404 and access to neighboring entries in the same memory line 416 are stored in linked list lines 420-0,..420-63 in linked lists 404 according to the memory line 416 in the external memory 414. Upon receiving the read data for the memory line 416, processing continues with block 606.

At block 606, the write-back engine 418 adds the data returned in response to the read request with the data in the linked list line 420 and writes the sum (result) to the memory line 416 in external memory 414. Processing continues with block 608.

At block 608, the write-back engine 418 sends a write request to write the sum stored in the linked list line 420 in the linked lists 404 to the memory line 416 in external memory 414.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

It is envisioned that aspects of the embodiments herein can be implemented in various types of computing and networking equipment, such as switches, routers and blade servers such as those employed in a data center and/or server farm environment. Typically, the servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities can typically employ large data centers with a multitude of servers. Each blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. An apparatus comprising:
packet processing circuitry to process a network packet, the packet processing circuitry including:
memory access circuitry, the memory access circuitry to:
collect evicted data in multiple data fields in a line, the multiple data fields to match data fields in a memory line in an external memory, the evicted data written to the multiple data fields at different times; and
perform a single read-modify-write operation to update the memory line in the external memory with the evicted data stored in the line.

2. The apparatus of claim 1, wherein the line and the memory line have N bytes, N is an integer multiple of 4 and each of the data fields in the line to store evicted data has N/4 bytes.

3. The apparatus of claim 1, wherein the evicted data is a counter.

4. The apparatus of claim 3, wherein the counter is a telemetry counter.

5. The apparatus of claim 3, wherein the counter is a statistical counter.

6. The apparatus of claim 1, wherein the external memory is a dynamic random access memory.

7. The apparatus of claim 2, wherein N is 64.

8. A method comprising:
processing, by packet processing circuitry, a network packet;
collecting, by memory access circuitry in the packet processing circuitry, evicted data in multiple data fields in a line, the multiple data fields to match data fields in a memory line in an external memory, the evicted data written to the multiple data fields at different times; and
performing, by the memory access circuitry, a single read-modify-write operation to update the memory line in the external memory with the evicted data stored in the line.

9. The method of claim 8, wherein the line and the memory line have N bytes, N is an integer multiple of 4 and each of the data fields in the line to store evicted data has N/4 bytes.

10. The method of claim 8, wherein the evicted data is a counter.

11. The method of claim 10, wherein the counter is a telemetry counter.

12. The method of claim 10, wherein the counter is a statistical counter.

13. The method of claim 8, wherein the external memory is a dynamic random access memory.

14. The method of claim 9, wherein N is 64.

15. A system comprising:
a memory node to provide access to a memory; and
a compute node, the compute node comprising a network processor, the network processor comprising:
packet processing circuitry to process a network packet, the packet processing circuitry including:
memory access circuitry, the memory access circuitry to:
collect evicted data in multiple data fields in a line, the multiple data fields to match data fields in a memory line in an external memory, the evicted data written to the multiple data fields at different times; and
perform a single read-modify-write operation to update the memory line in the external memory with the evicted data stored in the line.

16. The system of claim 15, wherein the line and the memory line have N bytes, N is an integer multiple of 4 and each of the data fields in the line to store an evicted data has N/4 bytes.

17. The system of claim 15, wherein the evicted data is a counter.

18. The system of claim 17, wherein the counter is a telemetry counter.

19. The system of claim 17, wherein the counter is a statistical counter.

20. The system of claim 15, wherein the memory is a dynamic random access memory.
